(19) United States
(12) Patent Application Publication
(10) Pub. No.: US 2006/0094625 A1
(43) Pub. Date: May 4, 2006

(54) Cleaning composition which renders a surface stain resistant

(76) Inventor: Isaac B. Horton III, Raleigh, NC (US)

Correspondence Address: Isaac B. Horton, III, 8824 Stage Ford Road, Raleigh, NC, 27615, US

(21) Appl. No.: 11/299,495

(22) Filed: Dec. 12, 2005

Related U.S. Application Data
(63) Continuation-in-part of application No. 10/868,464, filed on Jun. 15, 2004.

(51) Int. Cl. C11D 17/00

(52) U.S. Cl. 510/407

(57) ABSTRACT

A cleaning composition, in a concentrated form comprising a water-soluble organic solvent, at least one surfactant which comprises at least one amide, at least one additional surfactant, a chelating agent, at least one anti-resoiling agent, and distilled water. The preferred embodiment of the cleaning composition comprises all-natural components.

### CROSS-REFERENCE TO RELATED APPLICATIONS

This nonprovisional utility patent application is copending with nonprovisional application Ser. No. 10/868,649 filed on Jun. 15, 2004, and nonprovisional application Ser. No. 10/868,541 filed on Jun. 15, 2004, and nonprovisional application Ser. No. 10/868,464 filed on Jun. 15, 2004.

### BACKGROUND OF THE INVENTION

(1) Field of the Invention

The present invention relates generally to a cleaning composition and, more particularly, to an all-purpose cleaning composition which cleans and leaves a protective stain resistant coating on surfaces including textiles, glass, automobiles, and hard surfaces.

(2) Description of the Prior Art

There are a large number of cleaning products currently on the market. Typically, cleaning compositions, detergents, and the like contain a combination of many components including but not limited to anionic surfactants, cationic surfactants, nonionic surfactants, builders, suds-stabilizers, buffers, disinfecting agents, wetting agents, and chelating agents. Often these cleaning compositions employ components that may have adverse effects on the environment such as phosphorous compounds, peroxygen compounds, chlorine bleach compounds, and fluorinated compounds.

Prior art related to this invention is as follows:

U.S. Pat. No. 6,720,297 issued to Jenevein on Apr. 13, 2004 for a cleaning composition teaches a cleaning composition for treating and removing stains from a non-porous surface. The composition has one or more salts, such as quaternary ammonium salts, sulfates and chlorides, a chelator and a dispersant, dissolved in an aqueous solution of alcohol. The preferred salts are myristyltrimethylammonium bromide and benzethonium chloride, the chelator is tetrasodium salt ethylenediamine of tetraacetic acid, and the dispersant is polyvinyl alcohol. The cleaning composition is incorporated into a product, which has a non-woven polyester carrier impregnated with the cleaning composition.

U.S. Pat. No. 5,759,980 issued to Russo, et al. on Jun. 2, 1998 for a car wash teaches a novel car wash composition which substantially eliminates water-spotting. This novel car wash composition is comprised of: a surfactant package which is comprised of a first surfactant selected from the group consisting essentially of an anionic surfactant, a nonionic surfactant and mixtures thereof; and a second surfactant selected from the group consisting essentially of fluorosurfactant, a silicone surfactant, and mixtures thereof; and a substantive polymer that renders the surface to be cleaned more hydrophilic.

U.S. Pat. No. 6,732,747 issued to Wise on May 11, 2004 for a composition and method for cleaning and disinfecting a garbage disposal teaches an improved composition and method for cleaning and disinfecting a garbage disposal that does not require aerosol propellants or carbon dioxide gas generating reaction systems. The composition comprises a suds stabilizing surfactant and a disinfecting agent, plus other optional ingredients such as additional detergent surfactant and scouring agents. The required disinfecting agent is selected from the group consisting of quaternary ammonium compounds, halogenated compounds, phenolics, alcohols, aldehydes, oxidizing agents and mixtures thereof.

United States Patent Application Pub. No. 20040043041 filed by Baker, et al. on Mar. 4, 2004 for antimicrobial compositions and methods of use teaches compositions and methods for decreasing the infectivity, morbidity, and rate of mortality associated with a variety of pathogenic organisms and viruses. The reference invention also relates to methods and compositions for decontaminating areas colonized or otherwise infected by pathogenic organisms and viruses. Moreover, the reference invention relates to methods and compositions for decreasing the infectivity of pathogenic organisms in foodstuffs. In particular, decreased pathogenic organism infectivity, morbidity, and mortality are accomplished by contacting the pathogenic organism with an oil-in-water nanoemulsion comprising an oil, an organic solvent, and a surfactant dispersed in an aqueous phase. In some preferred embodiments, the solvent comprises an organic phosphate solvent. In still other embodiments, the organic phosphate-based solvent comprises dialkyl phosphates or trialkyl phosphates (e.g., tributyl phosphate).

United States Patent Application Pub. No. 20040127378 filed by Sherry, et. al. on Jul. 1, 2004 for hard surface cleaning composition and wipes teaches preferred, preferably liquid, hard surface cleaning compositions, said compositions comprising hydrophilic polymers to render the cleaned surface hydrophilic and to improve the appearance when the surface is either not rinsed, or when the composition is incompletely removed, specific surfactant, preferably surfactant selected to minimize spotting/filming, optionally specific organic cleaning solvents to provide cleaning and wetting particularly in applications where levels of non-volatiles need to be minimized, and, optionally, anti-bacterial agents for preserving or surface activity and optionally perfumes for aesthetics.

United States Patent Application Pub. No. 20020108640 filed by Barger, et. al. on Aug. 15, 2002 for a process for cleaning a surface wherein a surface, for example the exterior surface of a vehicle, is contacted with a cleaning composition capable of rendering the surface treated hydrophilic and then rinsed with purified rinse water. Preferably the process also involves a pre-wetting step, wherein the surface is rinsed with water prior to being contacted with the cleaning composition, and/or an additional rinsing step, wherein the surface is rinsed with unpurified water prior to rinsing with the purified rinse water.

While these compositions can lead to a useful cleaning agent, a simpler composition that retains superior cleaning activity while reducing the number of components could simplify the manufacturing process, potentially reducing production costs without sacrificing product quality. Further, many of these cleaning compositions employ components that may have adverse effects on the environment. Thus, there remains a need for a superior cleaning composition having a simple composition that is environmentally friendly, easily formulated, and cost effective.

For a variety of reasons consumers may want the surface they have cleaned to demonstrate certain properties such as stain resistance, hydrophilicity, or hydrophobicity. Therefore, it is an object of the present invention to provide a cleaning composition effective for the removal of soils which also comprises a surface enhancing agent to provide the cleaned surface with a protective coating which imparts the desired characteristics to that surface. More specifically, it is an object of the present invention to provide a cleaning composition effective for the removal of soils wherein the surface enhancing agent comprises an anti-resoiling agent, to render the cleaned surface stain resistant.

Surfaces that are hydrophobic have a low affinity for water. This low affinity will cause water droplets on hydrophobic surfaces to bead. This means that the contact angle, the angle between the water droplet and the surface, will be large, typically greater than 90 degrees. On the other hand, surfaces that are hydrophilic have a high affinity for water. These hydrophilic surfaces will cause water droplets to spread. The contact angle of a water droplet on a hydrophilic surface is between 0 and 90 degrees. Wetting occurs when the contact angle is zero and the “droplet” is actually a sheet of water.

One challenge in using surface enhancing additives is that the surface modification must be resistant to rinsing and in some cases repeated rinsing. To impart such characteristics to a surface a polymer or other additive must be capable of modifying the surface by adhesion or association through covalent or electrostatic interactions, hydrogen bonding, or van der Waals forces. The surface modification must remain on the surface during and after the cleaning process.

It is known in the art to use anti-resoiling agents wherein between successive washes of a surface, a polymer provides a protective layer onto which the soil deposits. Then in the next wash of the surface, the polymer layer is removed along with the soil deposited thereon and a replacement polymer layer is deposited. Known anti-resoiling agents include polyalkoxylene glycol diester, vinylpyrrolidone homopolymer or copolymer, polysaccharide polymer, polyalkoxylene glycol, mono- or di-capped polyalkoxylene glycol, or mixtures thereof. See United States Patent Application Pub. No. 20020160924 which is incorporated herein by reference in its entirety.

### SUMMARY OF THE INVENTION

The present invention is directed to a surface enhancing cleaning solution for use in cleaning a range of surfaces including but not limited to textiles, glass, automobiles, and hard surfaces. The cleaning solution further contains an anti-resoiling agent which will render the cleaned surface stain resistant. Thus, the present invention provides a cleaning composition comprising a water-soluble organic solvent, at least one surfactant which comprises at least one amide, a chelating agent, at least one anti-resoiling agent, and distilled water; thereby providing a superior cleaner having a simple composition that is easily formulated, and cost effective. The cleaning composition may further include at least one preservative. The cleaning composition may further include at least one clay derivative.

### DETAILED DESCRIPTION OF THE PREFERRED EMBODIMENTS

The present invention provides an all-purpose cleaner with superior cleaning ability for a range of materials including but not limited to textiles, glass, automobiles, and hard surfaces. The cleaner is a concentrated composition which is preferably diluted prior to distribution to consumers for end use, such as by bottlers. The cleaning composition contains the following components:

(a) at least one water-soluble organic solvent present in a solubilizing effective amount;

(b) a first surfactant which comprises at least one amide which may be the product of the saponification of at least one fatty acid by an amino alcohol in a water-soluble organic solvent, wherein the first surfactant is present in a cleaning-effective amount;

(c) at least one additional surfactant present in a cleaning-effective amount;

(d) a chelating agent capable of chelating multivalent metal ions, wherein the chelating agent is present in an amount effective to prevent phase reversal of the oil-in-water emulsifier; and

(e) at least one anti-resoiling agent capable of rendering a surface stain resistant, wherein the at least one anti-resoiling agent is present in an amount effective to impart stain resistance to a cleaned surface.

(f) the remainder, distilled water.

Additional adjuncts in small amounts such as fragrance, dye and the like can be included to provide desirable attributes of such adjuncts.

In the application, effective amounts are generally those amounts listed as levels of ingredients in the descriptions which follow hereto. Unless otherwise stated, amounts listed in percentages are in weight percents (%'s) of the composition.

Solvent

The solvent should be a water-soluble organic solvent. Further, the solvent is preferably a water-soluble organic alcohol. The most preferred water-soluble organic solvent is tetrahydrofurfuryl alcohol (THF-A). THF-A is an organic solvent that is completely miscible with water. THF-A has an extensive history of use as a highly versatile, high purity solvent. Due to its relatively benign nature and the fact that it is not oil-based, THF-A is generally regarded as a “green” solvent in industrial applications. THF-A readily biodegrades in soil, sludge, and water. The atmospheric half life is 13 hours. Unused THF-A is not classified as a hazardous waste under the Resource Conservation and Recovery Act.

Surfactants

The first surfactant is at least one amide. The preferred amide is at least one naturally occurring amide. The most preferred amide is a member of the group of amides comprising compounds with the structure CH₃(CH₂)ₓCONH(CH₂)₂OH, wherein the value of x is preferably any whole number between and including 14 and 22; CH₃(CH₂)ₓCH═CH(CH₂)_{y}CONH(CH₂)₂OH, wherein the value of x+y is preferably any whole number between and including 12 and 16; CH₃(CH₂)ₓCH═CH(CH₂)_{y}CH═CH(CH₂)_{z}CONH(CH₂)₂OH, wherein the value of x+y is preferably any whole number between and including 10 and 14; and mixtures thereof.

In another embodiment, the first surfactant may be the product of the saponification of at least one fatty acid by an amino alcohol in a water-soluble organic solvent. The preferred at least one fatty acid is chosen from the group comprising saturated fatty acids of the general formula CₓH₂ₓO₂, wherein the value of x is preferably any whole number between and including 16 and 24; monounsaturated or polyunsaturated fatty acids of the general formula CₓH_{(2x-y)}O₂, wherein the value of x is preferably any whole number between and including 16 and 20 and the value of y is preferably either 2 or 4; and combinations thereof. A more preferred fatty acid is one chosen from the group comprising palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and combinations thereof. The most preferred fatty acid is tall oil also known as pine oil. Tall oil is commercially available as MeadWestvaco L-5, marketed by MeadWestvaco, which comprises at least 95% tall oil fatty acid and less than 5% rosin acids. Any suitable fatty acid may contain rosin acids present in small amounts not to exceed about 5% by weight of the total weight of the fatty acid. The preferred amino alcohol is an ethanolamine. The most preferred amino alcohol is monoethanolamine.

The at least one additional surfactant is at least one polyethylene oxide condensate of an alkyl phenol. Suitable additional surfactants are octylphenol ethoxylates that have the chemical formula C₈H₁₇(C₆H₄)O(CH₂CH₂O)ₓH, wherein the average value of x for any mixture of these compounds is preferably any number between and including 3 and 11. Optimally two additional surfactant mixtures are used, wherein the average value of x for the first additional surfactant mixture is preferably 4.5, and wherein the average value of x for the second additional surfactant mixture is preferably 9.5. These preferred surfactant mixtures are commercially marketed under the names Triton X-45 and Triton X-100 by The Dow Chemical Company.

Chelating Agent

The chelating agent is required to chelate multivalent metal ions and thus prevent phase reversal of the oil-in-water emulsifier. The preferred chelating agent is an aminocarboxylic acid salt. The most preferred chelating agent is tetrasodium ethylenediaminetetraacetic acid (Na₄EDTA). This compound is commercially marketed as an aqueous solution of about 38% by weight Na₄EDTA under the name Versene by The Dow Chemical Company.

Anti-Resoiling Agent

The surface enhancing agent must be water soluble and must have surface activity such that it will be adsorbed to the cleaned surface from the cleaning composition. The anti-resoiling agent will increase the stain resistance of the surface. An anti-resoiling agent according to the present invention illustratively includes polyalkoxylene glycol diester, vinylpyrrolidone homopolymer or copolymer, polysaccharide polymer, polyalkoxylene glycol, mono- or di-capped polyalkoxylene glycol, or combinations thereof.

In one preferred embodiment the anti-resoiling agent is the homopolymer of N-vinylpyrrolidone. The degree of polymerization of a suitable N-vinylpyrrolidone homopolymer is preferably from 10 to 1,000,000. More preferably, the degree of polymerization is from 20 to 10,000.

In another embodiment the anti-resoiling agent is a copolymer of N-vinylpyrrolidone and an alkylenically unsaturated monomer or combinations thereof. The alkylenically unsaturated monomer may be an unsaturated carboxylic acid, an anhydride of the unsaturated carboxylic acid, or an aromatic monomer such as styrene, sulfonated styrene, alpha-methyl styrene, vinyl toluene, t-butyl styrene. The preferred molecular weight of these copolymers of N-vinylpyrrolidone and alkylenically unsaturated monomers is between 1,000 and 1,000,000. The molecular weight of these copolymers is most preferably between 10,000 and 200,000.

Other suitable anti-resoiling agents include polysaccharide polymers. Particularly preferred polysaccharide polymers are xanthan gum and derivatives thereof.

In preferred embodiments, environmentally friendly polymers useful for rendering a surface stain resistant are used with the present invention.

The anti-resoiling agent is preferably present in the composition at a level of up to 20% by weight. Preferably the anti-resoiling agent is present from 0.001% to 10%, more preferably from 0.01% to 5%, most preferably from 0.01% to 1% by weight of the composition.

The anti-resoiling agent may comprise clay derivatives which can enhance the hydrophilicity of the surface thereby enhancing the sheeting action of water on the cleaned surface. Clay derivatives which are suitable for use in the present invention illustratively include synthetic magnesium phyllosilicates (Laponite).

Water and Miscellaneous

The invention comprises a cleaning concentrate. Water may be present at levels of between about 6% and about 99.6% by volume. The most preferred amount of water is between about 47% and about 53% by volume. The preferred embodiment of this invention is a concentrated formulation which is preferably further diluted with water before end use.

Some of the amides and acids that are present in this composition are known to undergo intermolecular and intramolecular Diels-Alder cyclization reactions. Some of the products of those reactions are known to have biological activity. Because these products are present in the cleaning composition of the current invention, and these products show biological activity, no additional biocide is necessary in this composition. By way of example, but not limitation one of these cyclization products is cyclopinolenic acid.

Additionally, small amounts of adjuncts may be added to the composition for aesthetic qualities. These adjuncts include perfumes and dyes.

The invention further provides a method for formulating the cleaning concentrate. The method of formulating the cleaning composition of the present invention relies upon adherence to certain process parameters that lead to a unique product. The order of addition of the various components is critical. It is also vital that the process temperature be maintained throughout the procedure.

The composition is formulated in a reactor. The preferred reactor is a glass or Hastelloy reactor equipped with a reflux condenser and a means of stirring. The means of stirring may be a stir bar or agitator. The reactor should be clean prior to the reaction.

The reactor is charged with a water-soluble organic solvent. A suitable amount of water-soluble organic solvent is between about 3% and about 16% by weight of the total composition. The most preferred amount of water-soluble organic solvent is between about 3% and about 9% by weight of the total composition. In a preferred embodiment the water-soluble organic solvent is a water-soluble organic alcohol. In the most preferred embodiment the water-soluble organic solvent is tetrahydrofurfuryl alcohol (THF-A).

The reactor is charged with an amino alcohol. The stirring mechanism is employed while the reactor is charged with the amino alcohol. The stirring mechanism is continuously employed during the remainder of the process. A suitable amount of amino alcohol is between about 3% and about 9% by weight of the total composition. The amino alcohol undergoes a chemical reaction with the fatty acid in a 1 to 1 mole ratio. However, in the preferred embodiment the fatty acid is present in excess amounts. In a preferred embodiment the amino alcohol is an ethanolamine. In the most preferred embodiment the amino alcohol is monoethanolamine.

The contents of the reactor must be heated. The preferred temperature range for this process is between 75 and 90 degrees Celsius (C). The most preferred temperature range for this process is between 80 and 85 degrees C. This temperature range is maintained throughout the process. Immediately following additions of various components the batch temperature may fall below this range. At no time should the temperature be allowed to fall below 55 degrees C. The batch temperature should recover quickly to the required range.

At least one fatty acid is added to the reactor. A suitable amount of the at least one fatty acid is between about 7% and about 14% by weight of the total composition. The fatty acid is added via a clean gravity feed vessel. Alternatively a pump type vessel may be employed for the addition. After addition of the fatty acid the contents of the reactor are stirred for a first time period during which the reaction is monitored until it is complete. The reaction may be determined to be complete by any convenient method used in the art. Suitable methods include thin layer chromatography and high performance liquid chromatography.

After the reaction is determined to be complete, a first portion of distilled water is added rapidly. A suitable amount of the first portion of distilled water is between about 1% and about 9% by weight of the total composition. The mixture is stirred for a second time period which is sufficient to allow the composition to form a homogeneous mixture. Preferably the mixture is stirred for at least 10 minutes. The stirring time may increase dramatically corresponding with a scale-up of the process.

The at least one additional surfactant is rapidly added to the reactor. A suitable amount of each additional surfactant is between about 7% and about 30% by weight of the total composition. The most preferred amount of each additional surfactant is between about 8% and about 30% by weight of the total composition. The mixture is stirred for a time period which is sufficient to allow the composition to form a homogeneous mixture. Preferably the mixture is stirred for at least 10 minutes. The stirring time may increase dramatically corresponding with a scale-up of the process.

The chelating agent is added to the reactor. The preferred amount of chelating agent is between about 2% and about 8% by weight of the total composition. The chelating agent may be added to the present composition as an aqueous solution. In a preferred embodiment the chelating agent is added to the composition as an aqueous solution, and the chelating agent is present at a concentration of between about 36% and about 40% by weight in the aqueous solution. A commercially available aqueous solution of a chelating agent, such as Versene, may be used. A suitable amount of the aqueous solution of chelating agent is between about 7% and about 19% by weight of the total composition. The most preferred amount of the aqueous solution of chelating agent is between about 8% and about 19% by weight of the total composition.

The at least one anti-resoiling agent is added to the reactor. A suitable amount of anti-resoiling agent is between about 0.001% and about 10% by weight of the total composition. The most preferred amount of anti-resoiling agent is between about 0.01% and about 1% by weight of the total composition. The mixture is stirred for a time period which is sufficient to allow the composition to form a homogeneous mixture.

Distilled water is added to the reactor. The distilled water makes up the balance of the composition. A preferred amount of distilled water for the second addition of distilled water is between about 4% and about 44% by weight of the total composition. The composition is allowed to cool to within 25 to 30 degrees C.

Optionally, after cooling and prior to commercial distribution, the composition may be passed through a filter to remove any debris acquired during the processing steps.

Certain modifications and improvements will occur to those skilled in the art upon a reading of the foregoing description. By way of example, applications for this cleaning composition may be extended to a cleaner for aircrafts which have exterior coatings similar or identical to automobiles. All modifications and improvements have been deleted herein for the sake of conciseness and readability but are properly within the scope of the following claims.

### DESIGN EXAMPLE(S)

This section outlines a design example, not necessarily optimized but illustrative of a suitable method, wherein the cleaning composition of the current invention may be formulated.

### Example

In this preferred embodiment of the method of formulating a cleaning composition in a concentrated form a reactor is charged with tetrahydrofurfuryl alcohol. The reactor is then charged with monoethanolamine, wherein the volume of monoethanolamine is one half the volume of the tetrahydrofurfuryl alcohol. The contents of the reactor are heated to within the range of 80 to 90 degrees C. The reactor is charged with tall oil (MeadWestvaco L-5) acquired from MeadWestvaco. The volume of tall oil is equal to the volume of the tetrahydrofurfuryl alcohol. The contents of the reaction are stirred until the reaction is determined to be complete. The reaction progress is followed by thin layer chromatography. The reactor is charged with a first portion of distilled water, wherein the volume of the first portion of distilled water is equal to the volume of the tetrahydrofurfuryl alcohol. The contents of the reaction are stirred for ten minutes. The reactor is charged with the additional surfactants Triton X-100 and Triton X-45, acquired from the Dow Chemical Company, wherein the amount of each additional surfactant is equal to the volume of the tetrahydrofurfuryl alcohol. The contents of the reactor are stirred for ten minutes. The reactor is charged with the commercially available aqueous solution of tetrasodium ethylenediaminetetraacetic acid Versene, wherein the amount of Versene is equal to the volume of the tetrahydrofurfuryl alcohol. The reactor is charged with the anti-resoiling agent, wherein the amount of the anti-resoiling agent is 0.5% by weight of the final composition. The reactor is charged with a second portion of distilled water, wherein the volume of the second portion of distilled water is equal to five times the volume of the tetrahydrofurfuryl alcohol, and the mixture is allowed to cool to about room temperature.

What is claimed is:

1. A cleaning composition in a concentrated form comprising:
(a) a water-soluble organic solvent,
(b) at least one amide surfactant,
(c) at least one additional surfactant,
(d) a chelating agent,
(e) at least one anti-resoiling agent, and
(f) the remainder distilled water.

2. The cleaning composition according to claim 1, wherein the water-soluble organic solvent is a water-soluble organic alcohol.

3. The cleaning composition according to claim 1, wherein the amount of water-soluble organic solvent is between about 3% and about 16% by weight of the total composition.

4. The cleaning composition according to claim 1, wherein the at least one amide surfactant is the product of the saponification of at least one fatty acid by an amino alcohol.

5. The cleaning composition according to claim 4, wherein the amino alcohol is an ethanolamine.

6. The cleaning composition according to claim 4, wherein the amount of amino alcohol is between about 3% and about 9% by weight of the total composition.

7. The cleaning composition according to claim 4, wherein the amount of the at least one fatty acid is between about 7% and about 14% by weight of the total composition.

8. The cleaning composition according to claim 4, wherein the at least one fatty acid is chosen from the group comprising saturated fatty acids of the general formula CₓH₂ₓO₂, wherein the value of x is any whole number between and including 16 and 24; monounsaturated or polyunsaturated fatty acids of the general formula CₓH_{(2x-y)}O₂, wherein the value of x is any whole number between and including 16 and 20 and y is either 2 or 4; and mixtures thereof.

9. The cleaning composition according to claim 4, wherein the at least one fatty acid is chosen from the group consisting of palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and combinations thereof.

10. The cleaning composition according to claim 1, wherein the at least one amide surfactant is at least one fatty acid amide.

11. The cleaning composition according to claim 10, wherein the at least one fatty acid amide is a member of the group of amides comprising compounds with the structure CH₃(CH₂)ₓCONH(CH₂)₂OH, wherein the value of x is any whole number between and including 14 and 22; CH₃(CH₂)ₓCH═CH(CH₂)_{y}CONH(CH₂)₂OH, wherein the value of x+y is any whole number between and including 12 and 16; CH₃(CH₂)ₓCH═CH(CH₂)_{y}CH═CH(CH₂)_{z}CONH(CH₂)₂OH, wherein the value of x+y is any whole number between and including 10 and 14; and mixtures thereof.

12. The cleaning composition according to claim 1, wherein the amount of the chelating agent is between about 2% and about 8% by weight of the total composition.

13. The cleaning composition according to claim 1, wherein the amount of the at least one anti-resoiling agent is between about 0.001% and about 10% by weight of the total composition.

14. The cleaning composition according to claim 1, wherein the at least one anti-resoiling agent is selected from the group consisting of homopolymers of N-vinylpyrrolidone, copolymers of N-vinylpyrrolidone and alkylenically unsaturated monomers, polysaccharide polymers, and combinations thereof.

15. A cleaning composition in a concentrated form comprising:
(a) a water-soluble organic solvent;
(b) at least one amide surfactant, wherein the at least one amide surfactant is the product of the saponification of at least one fatty acid by an amino alcohol;
(c) at least one additional surfactant, wherein the at least one additional surfactant is a polyethylene oxide condensate of an alkylphenol;
(d) a chelating agent, wherein the chelating agent is an aminocarboxylic acid salt; and
(e) at least one anti-resoiling agent
(f) the remainder distilled water.

16. The cleaning composition according to claim 15, wherein the water-soluble organic solvent is a water-soluble organic alcohol.

17. The cleaning composition according to claim 15, wherein the amount of amino alcohol is between about 3% and about 9% by weight of the total composition.

18. The cleaning composition according to claim 15, wherein the at least one fatty acid is chosen from the group consisting of saturated fatty acids of the general formula CₓH₂ₓO₂, wherein the value of x is any whole number between and including 16 and 24; monounsaturated or polyunsaturated fatty acids of the general formula CₓH_{(2x-y)}O₂, wherein the value of x is any whole number between and including 16 and 20 and y is either 2 or 4; and combinations thereof.

19. The cleaning composition according to claim 15, wherein the at least one fatty acid is selected from the group consisting of palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and combinations thereof.

20. The cleaning composition according to claim 15, wherein the at least one fatty acid is tall oil, also known as pine oil.
